(19) United States
(12) Patent Application Publication
(10) Pub. No.: US 2025/0096929 A1
(43) Pub. Date: Mar. 20, 2025

(54) LONGER LOW-DENSITY PARITY CHECK (LDPC) CODE SIGNALING IN ULTRA HIGH RELIABILITY (UHR) SYSTEMS

(71) Applicant: QUALCOMM Incorporated, San Diego, CA (US)

(72) Inventors: Kanke WU, San Diego, CA (US); Sameer VERMANI, San Diego, CA (US); Bin TIAN, San Diego, CA (US)

(21) Appl. No.: 18/415,437

(22) Filed: Jan. 17, 2024

Related U.S. Application Data
(60) Provisional application No. 63/583,235, filed on Sep. 15, 2023.

(51) Int. Cl. H04L 1/00; H04W 28/04

(52) U.S. Cl. CPC H04L 1/0057; H04W 28/04

(57) ABSTRACT

This disclosure provides methods, components, devices and systems for managing long low-density parity check (LDPC) codewords in ultra high reliability (UHR) systems. One method for wireless communication may be performable at a transmitter device or node. The method may include transmitting signaling to a receiver device or node indicating that the transmitter device supports use of a first LDPC codeword length that is greater than or equal to a threshold LDPC codeword length. The method may further include transmitting an LDPC codeword of the first LDPC codeword length (e.g., a long LDPC codeword) to the receiver device when one or more conditions are satisfied.

### CROSS-REFERENCE TO RELATED APPLICATION

This application claims benefit of and priority to U.S. Provisional Patent Application No. 63/583,235, filed Sep. 15, 2023, which is hereby incorporated by reference in its entirety.

### TECHNICAL FIELD

This disclosure relates generally to wireless communication, and more specifically, to managing long low-density parity check (LDPC) codewords in ultra high reliability (UHR) systems.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods and devices of this disclosure each have several innovative aspects, no single one of which is solely responsible for the desirable attributes disclosed herein.

One innovative aspect of the subject matter described in this disclosure can be implemented at a first wireless node for wireless communication. The first wireless node includes at least one memory including instructions; and one or more processors configured, individually or in any combination, to execute the instructions and cause the first wireless node to: output first signaling indicating that the first wireless node supports use of a first low-density parity check (LDPC) codeword length that is greater than or equal to a threshold LDPC codeword length; and output an LDPC codeword of the first LDPC codeword length when one or more conditions are satisfied.

Another innovative aspect of the subject matter described in this disclosure can be implemented as a method for wireless communication performable at a first wireless node. The method may include outputtingfirst signaling indicating that the first wireless node supports use of a first LDPC codeword length that is greater than or equal to a threshold LDPC codeword length; and outputting an LDPC codeword of the first LDPC codeword length when one or more conditions are satisfied.

Another innovative aspect of the subject matter described in this disclosure can be implemented at a first wireless node for wireless communication. The first wireless node includes at least one memory including instructions; and one or more processors configured, individually or in any combination, to execute the instructions and cause the first wireless node to: obtain first signaling indicating that a second wireless node supports use of a first LDPC codeword length that is greater than or equal to a threshold LDPC codeword length; and obtain, when one or more conditions are satisfied, an LDPC codeword of the first LDPC codeword length.

Another innovative aspect of the subject matter described in this disclosure can be implemented as a method for wireless communication performable at a first wireless node. The method may include obtaining first signaling indicating that a second wireless node supports use of a first LDPC codeword length that is greater than or equal to a threshold LDPC codeword length; and obtaining, when one or more conditions are satisfied, an LDPC codeword of the first LDPC codeword length.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example physical layer PDU (PPDU) usable for communications between a wireless AP and one or more wireless STAs.

FIG. 4 shows a pictorial diagram of another example wireless communication network.

FIG. 5 shows an example PPDU usable for communications between a wireless AP and one or more STAs.

FIG. 6 shows a graphical representation of an example low-density parity check (LDPC) code or codeword.

FIG. 7 shows a matrix representation of an example LDPC code.

FIG. 8 shows a graphical representation of liftings of an example LDPC code.

FIG. 9 shows an integer representation of a matrix for a quasi-cyclic LDPC code.

FIG. 10 shows a first table for a number of available bits, a number of LDPC codewords, and lengths of LDPC codewords.

FIG. 11 shows a call flow diagram illustrating example communication among various devices.

FIG. 12 shows a second table for a number of available bits, a number of LDPC codewords, and lengths of LDPC codewords.

FIG. 13 shows a third table for a number of available bits, a number of LDPC codewords, and lengths of LDPC codewords.

FIG. 14 shows a fourth table for a number of available bits, a number of LDPC codewords, and lengths of LDPC codewords.

FIGS. 15 and 16 show example bits carried by physical layer (PHY) header signals for indicating use or no use of one or more long LDPC codewords.

FIG. 17 shows a flowchart illustrating an example process or method performable at a first wireless node.

FIG. 18 shows another flowchart illustrating an example process or method performable at a first wireless node.

FIG. 19 shows a block diagram of an example wireless communication device or node.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to wireless communication. Some aspects of the present disclosure provide apparatuses, methods, processing systems, and computer-readable mediums for managing long low-density parity check (LDPC) codewords in ultra high reliability (UHR) systems.

As Wi-Fi applications evolve, their demand for higher data rate, lower latencies and higher reliability connection also continuously increases. For latency sensitive applications, UHR systems may provide improvements in terms of maximum latency and jitter compared to other systems. For example, the UHR systems may provide a reliable Wi-Fi connection with the lower latencies by supporting multiple wireless devices or nodes coordination and transmission. For example, with the multi-device coordination and transmission, multiple independent wireless devices may be able to coordinate their transmission parameters (e.g., transmission power, transmission frequency) such that their transmissions do not interfere with each other and thereby providing a reliable connection.

In some cases, a protocol such as a hybrid automatic repeat request (HARQ) protocol may support various signaling between transmitter and receiver devices or nodes as well as signaling between physical (PHY) and medium access control (MAC) layers to improve retransmission operations. HARQ uses a combination of error detection and error correction techniques. For example, a HARQ transmission may include error checking bits that are added to data to be transmitted using an error-detecting (ED) code, such as a cyclic redundancy check (CRC). The error checking bits may be used by the receiver device to determine if it has properly decoded the received HARQ transmission.

In some examples, original data (e.g., information bits) to be transmitted may be encoded with an error correcting code, such as a LDPC codeword using a LDPC coding scheme that systematically encodes the information bits to produce parity bits. The transmitter device may transmit both the original information bits as well as the parity bits in the HARQ transmission to the receiver device. The receiver device may be able to use the parity bits to correct errors in the information bits, thus avoiding a retransmission.

Certain systems may support a limited number of codeword lengths for LDPC codewords. For example, some systems may support LDPC codeword lengths of 648, 1296, and 1944 bits for the LDPC codewords.

In some cases, a longer LDPC codeword (e.g., with a codeword length of 2x1944 or 4x1944 bits) may be beneficial, but longer codeword lengths for the LDPC codewords are not typically supported. Only under certain situations, some of the wireless devices may provide limited support for the use of the longer codeword lengths for the LDPC codewords. So, when a wireless device wants to use long LDPC codewords during encoding of a data packet, the wireless device may need to communicate (negotiate) with other wireless devices regarding the possible usage of the long LDPC codewords (e.g., to check if these other wireless devices can provide any support for the usage and processing of the long LDPC codewords at their end).

Techniques described herein may enable a wireless device to use a long LDPC codeword. To decide if the long LDPC codeword can be used, a transmitter device (e.g., for regular transmissions) or a receiver device (e.g., for trigger-based transmissions) may determine whether both the transmitter device and the receiver device may support use (and processing) of the long LDPC codeword and that some other conditions have also been satisfied.

In some aspects, the transmitter device may indicate use (or possible use) of a longer LDPC codeword to other receiver devices via a combination of a codeword length look up table, capability information indicating support for the use of the long LDPC codeword, and other conditions. In some cases, a special field may be defined in a PHY header to indicate whether 2x1944 or 4x1944 bits LDPC codeword has been used by the transmitter device in encoding.

### Example Wireless Communication Network

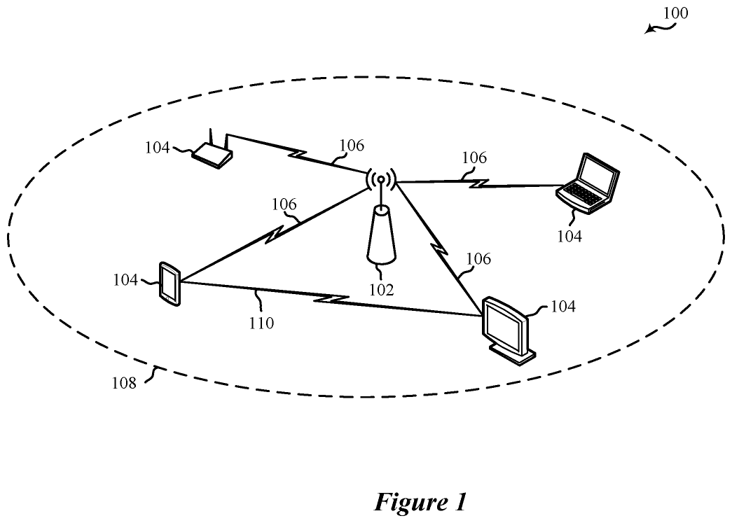

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless access point (AP) 102 and multiple wireless stations (STAs) 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHZ and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload

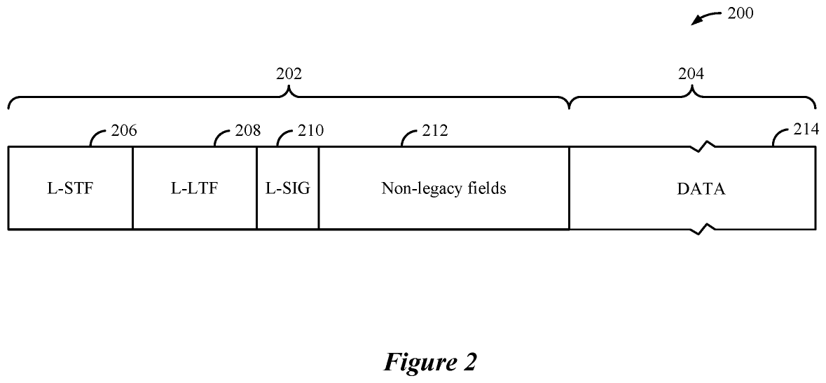

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

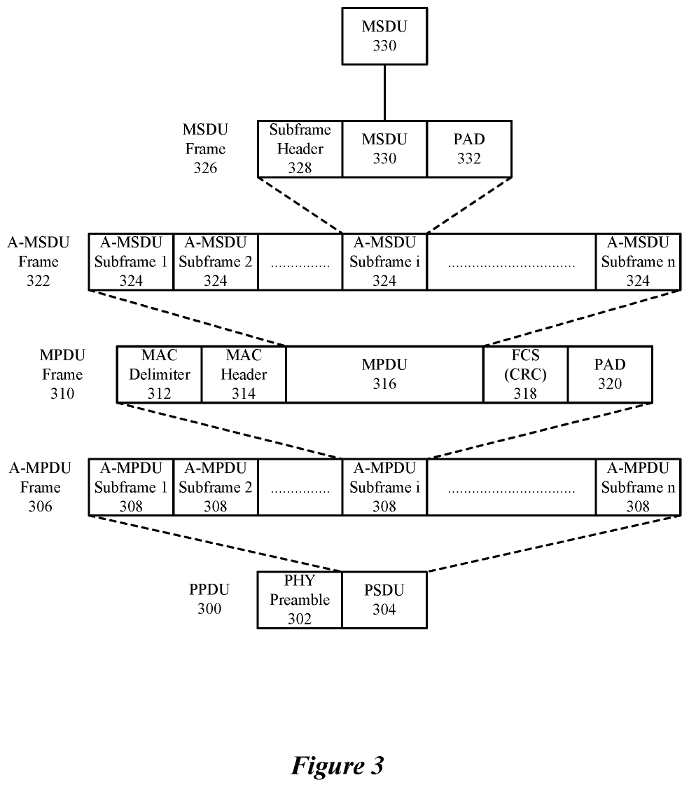

FIG. 3 shows a hierarchical format of an example PPDU usable for communications between a wireless AP 102 and one or more wireless STAs 104. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field may include a cyclic redundancy check (CRC)) and padding bits 320. The MPDU 316 may carry one or more MAC service data units (MSDUs) 316. For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body 316. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body 316. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

Some APs and STAs may implement techniques for spatial reuse that involve participation in a coordinated communication scheme. According to such techniques, an AP may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP, The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some other examples of OFDMA techniques, each portion of the plurality of portions of the TXOP includes a set of frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units (RUs) associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or EDCA techniques. Additionally, by enabling a group of APs associated with different BSSs to participate in a coordinated AP transmission session, during which the group of APs may share at least a portion of a single TXOP obtained by any one of the participating APs, such techniques may increase throughput across the BSSs associated with the participating APs and may also achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, an RX power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

Retransmission protocols, such as hybrid automatic repeat request (HARQ), also may offer performance gains. A HARQ protocol may support various HARQ signaling between transmitting and receiving wireless communication devices or nodes as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, If a receiving device cannot properly decode (and cannot correct the errors) a first HARQ transmission received from the transmitting device, the receiving device may transmit a HARQ feedback message to the transmitting device (for example, a negative acknowledgement (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an ARQ protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

Some wireless communication devices (including both APs and STAs) are capable of multi-link operation (MLO). In some examples, MLO supports establishing multiple different communication links (such as a first link on the 2.4 GHz band, a second link on the 5 GHz band, and the third link on the 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

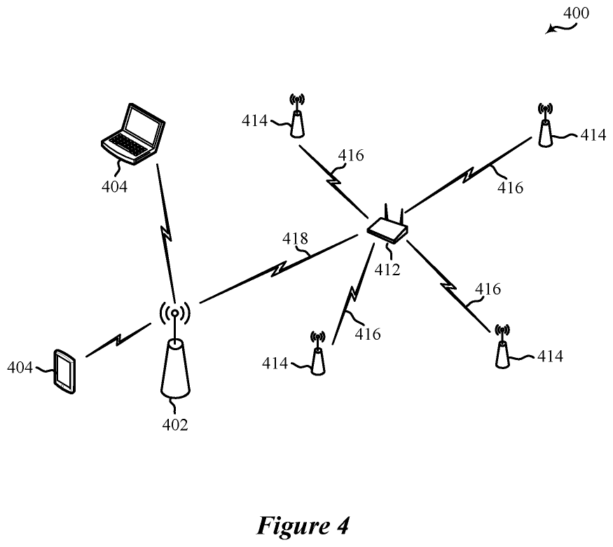

FIG. 4 shows a pictorial diagram of another example wireless communication network 400. According to some aspects, the wireless communication network 400 can be an example of a mesh network, an IoT network or a sensor network in accordance with one or more of the IEEE 802.11 family of wireless communication protocol standards (including the 802.11ah amendment). The wireless network 400 may include multiple wireless communication devices 414. The wireless communication devices 414 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 414 sense, measure, collect or otherwise obtain and process data and then transmit such raw or processed data to an intermediate device 412 for subsequent processing or distribution. Additionally or alternatively, the intermediate device 412 may transmit control information, digital content (for example, audio or video data), configuration information or other instructions to the wireless communication devices 414. The intermediate device 412 and the wireless communication devices 414 can communicate with one another via wireless communication links 416. In some examples, the wireless communication links 416 include Bluetooth links or other PAN or short-range communication links.

In some examples, the intermediate device 412 also may be configured for wireless communication with other networks such as with a Wi-Fi WLAN or a wireless (for example, cellular) wide area network (WWAN), which may, in turn, provide access to external networks including the Internet. For example, the intermediate device 412 may associate and communicate, over a Wi-Fi link 418, with an AP 402 of a WLAN network, which also may serve various STAs 404. In some examples, the intermediate device 412 is an example of a network gateway, for example, an IoT gateway. In such a manner, the intermediate device 412 may serve as an edge network bridge providing a Wi-Fi core backhaul for the IoT network including the wireless communication devices 414. In some examples, the intermediate device 412 can analyze, preprocess and aggregate data received from the wireless communication devices 414 locally at the edge before transmitting it to other devices or external networks via the Wi-Fi link 418. The intermediate device 412 also can provide additional security for the IoT network and the data it transports.

Aspects of transmissions may vary according to a distance between a transmitter (for example, an AP 102 or a STA 104) and a receiver (for example, another AP 102 or STA 104). Wireless communication devices may generally benefit from having information regarding the location or proximities of the various STAs 104 within the coverage area. In some examples, relevant distances may be determined (for example, calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

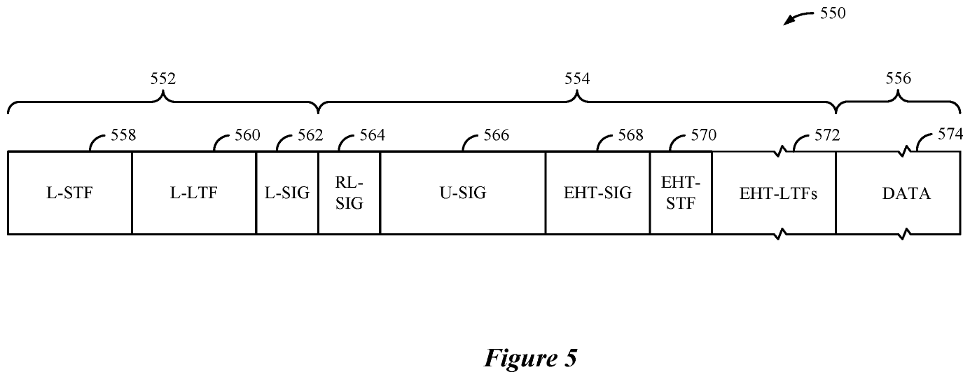

FIG. 5 shows an example PPDU 550 usable for communications between a wireless AP and one or more STAs. As shown, a legacy portion 552 of a preamble of the PPDU 550 includes an L-STF 558, an L-LTF 560, and an L-SIG 562. The non-legacy portion 554 of the preamble includes a repetition of L-SIG (RL-SIG) 564 and multiple wireless communication protocol version-dependent signal fields after RL-SIG 564. For example, the non-legacy portion 554 may include a universal signal field 566 (referred to herein as “U-SIG 566”) and an EHT signal field 568 (referred to herein as “EHT-SIG 568”). The presence of RL-SIG 564 and U-SIG 566 may indicate to EHT- or later version-compliant STAs 104 that the PPDU 550 is an EHT PPDU or a PPDU conforming to any later (post-EHT) version of a new wireless communication protocol conforming to a future IEEE 802.11 wireless communication protocol standard. One or both of U-SIG 566 and EHT-SIG 568 may be structured as, and carry version-dependent information for, other wireless communication protocol versions associated with amendments to the IEEE family of standards beyond EHT. For example, U-SIG 566 may be used by a receiving device to interpret bits in one or more of EHT-SIG 568 or the data field 574. Like L-STF 558, L-LTF 560, and L-SIG 562, the information in U-SIG 566 and EHT-SIG 568 may be duplicated and transmitted in each of the component 20 MHz channels in instances involving the use of a bonded channel.

The non-legacy portion 554 further includes an additional short training field 570 (referred to herein as “EHT-STF 570,” although it may be structured as, and carry version-dependent information for, other wireless communication protocol versions beyond EHT) and one or more additional long training fields 572 (referred to herein as “EHT-LTFs 572,” although they may be structured as, and carry version-dependent information for, other wireless communication protocol versions beyond EHT). EHT-STF 570 may be used for timing and frequency tracking and AGC, and EHT-LTF 572 may be used for more refined channel estimation.

EHT-SIG 568 may be used by an AP to identify and inform one or multiple STAs 104 that the AP has scheduled UL or DL resources for them. EHT-SIG 568 may be decoded by each compatible STA 104 served by the AP 102. EHT-SIG 568 may generally be used by a receiving device to interpret bits in the data field 574. For example, EHT-SIG 568 may include RU allocation information, spatial stream configuration information, and per-user (for example, STA-specific) signaling information. Each EHT-SIG 568 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 574.

### Example Low Density Parity Codes

In order for transmissions over the air interface to obtain a low block error rate (BLER) while still achieving very high data rates, channel coding may be used. That is, wireless communication may utilize a suitable error correcting block code. In a block code, an information message or sequence is split up into code blocks (CBs), and an encoder at a transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G new radio (NR) specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

LDPC codes can be represented by bipartite graphs (often referred to as “Tanner graphs”). In a bipartite graph, a set of variable nodes corresponds to bits of a code word (e.g., information bits or systematic bits), and a set of check nodes correspond to a set of parity-check constraints that define the code. Edges in the graph connect variable nodes to check nodes. Thus, the nodes of the graph are separated into two distinctive sets and with edges connecting nodes of two different types, variable and check.

Graphs as used in LDPC coding may be characterized in a variety of manners. A lifted code is created by copying a bipartite base graph (G) (or a protograph), a number of times, Z. The number of times is referred to herein as the lifting, lifting size, or lifting size value. A variable node and a check node are considered “neighbors” if they are connected by an “edge” (i.e., the line connecting the variable node and the check node) in the graph. In addition, for each edge (e) of the bipartite base graph (G), a permutation (generally an integer value associated with the edge permutation that is represented by k and referred to as the lifting value) is applied to the Z copies of edge (e) to interconnect the Z copies of G. A bit sequence having a one-to-one association with the variable node sequence is a valid code word if and only if, for each check node, the bits associated with all neighboring variable nodes sum to 0 modulo 2 (i.e., they include an even number of 1's). The resulting LDPC code may be quasi-cyclic (QC) if the permutations (liftings values) used are cyclic.

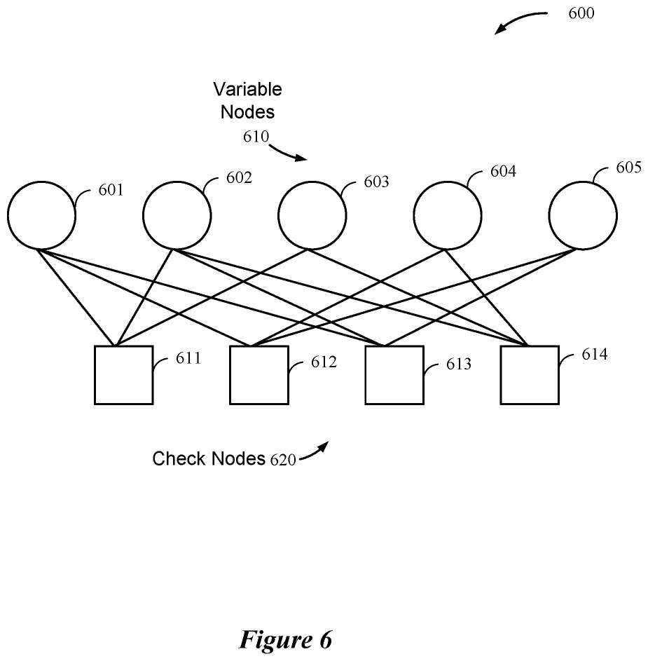

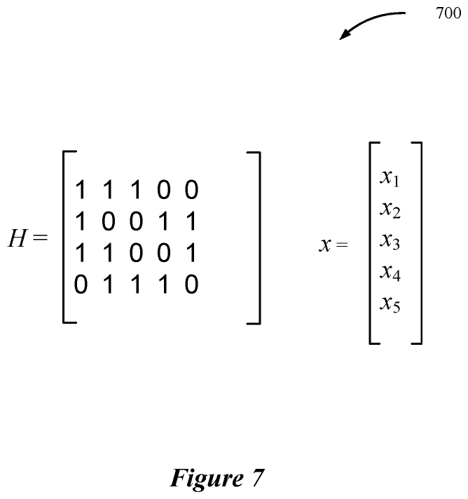

FIGS. 6 and 7 show graphical and matrix representations, respectively, of an example LDPC code, in accordance with certain aspects of the present disclosure. For example, FIG. 6 shows a bipartite graph 600 representing an example LDPC code. Bipartite graph 600 includes a set of five variable nodes 610 (represented by circles) connected to four check nodes 620 (represented by squares). Edges in bipartite graph 600 connect variable nodes 610 to check nodes 620 (the edges are represented by the lines connecting variable nodes 610 to check nodes 620). Bipartite graph 600 consists of |V|=5 variable nodes and |C|=4 check nodes, connected by |E|=12 edges.

Bipartite graph 600 may be represented by a simplified adjacency matrix, which may also be known as a parity check matrix (PCM). FIG. 7 shows a matrix representation 700 of bipartite graph 600. Matrix representation 700 includes a PCM H and a code word vector x, where x₁-x₅ represent bits of the code word x. H is used for determining whether a received signal was normally decoded. H has C rows corresponding to j check nodes and V columns corresponding to i variable nodes (i.e., a demodulated symbol), where the rows represent the equations and the columns represents the bits of the code word. In a diagram of FIG. 7, matrix H has four rows and five columns corresponding to four check nodes and five variable nodes, respectively. If a j-th check node is connected to an i-th variable node by an edge (i.e., the two nodes are neighbors), then there is a 1 in the i-th column and in the j-th row of the parity check matrix H. That is, the intersection of an i-th row and a j-th column contains a “1” where an edge joins the corresponding vertices and a “0” where there is no edge. The code word vector x represents a valid code word if and only if Hₓ=0, for example, if for each constraint node, the bits neighboring the constraint, via their association with variable nodes, sum to 0 modulo 2 (i.e., they comprise an even number of 1′a). Thus, if the code word is received correctly, then Hₓ=0 (mod 2). When the product of a coded received signal and the PCM H becomes ‘0’, this signifies that no error has occurred.

The number of demodulated symbols or variable nodes is the LDPC code length. The number of non-zero elements in a row (column) is defined as the row (column) weight d(c)d(v). The degree of a node refers to the number of edges connected to that node. For example, as shown in FIG. 6, the variable node 601 has three degrees of connectivity, with edges connected to check nodes 611, 612, and 613. Variable node 602 has three degrees of connectivity, with edges connected to check nodes 611, 613, and 614. Variable node 603 has two degrees of connectivity, with edges connected to check nodes 611 and 614. Variable node 604 has two degrees of connectivity, with edges connected to check nodes 612 and 614. And variable node 605 has two degrees of connectivity, with edges connected to check nodes 612 and 613. This feature is illustrated in the matrix H shown in FIG. 7 where the number of edges incident to a variable node 610 is equal to the number of 1's in the corresponding column and is called the variable node degree d (v). Similarly, the number of edges connected with a check node 620 is equal to the number of ones in a corresponding row and is called the check node degree d (c). For example, as shown in FIG. 7, the first column in the matrix H corresponds to the variable node 601 and the corresponding entries in the column (1, 1, 1, 0) indicates the edge connections to the check nodes 611, 612, and 613, while the 0 indicates that there is not an edge to check node 614. The entries in the second, third, fourth, and fourth columns of H represent the edge connections of the variable nodes 602, 603, 604, and 605, respectively, to the check nodes.

A regular graph or a regular code is one for which all variable nodes have the same degree and all constraint nodes have the same degree. On the other hand, an irregular code has constraint nodes and/or variable nodes of differing degrees. For example, some variable nodes may be of degree 4, others of degree 3, and still others of degree 2.

“Lifting” enables LDPC codes to be implemented using parallel encoding and/or decoding implementations while also reducing the complexity typically associated with large LDPC codes. Lifting helps enable efficient parallelization of LDPC decoders while still having a relatively compact description. More specifically, lifting is a technique for generating a relatively large LDPC code from multiple copies of a smaller base code. For example, a lifted LDPC code may be generated by producing Z of parallel copies of the base graph (e.g., protograph) and then interconnecting the parallel copies through permutations of edge bundles of each copy of the base graph. The base graph defines the (macro) structure of the code and consists of a number (K) of information bit columns and a number (N) of code bit columns. Lifting the base graph a number of liftings Z results in a final block length of KZ. Thus, a larger graph can be obtained by a “copy and permute” operation where multiple copies of the base graph are made and connected to form a single lifted graph. For the multiple copies, like edges are a set of copies of single base edge, are permutated and connected to form a connected graph Z times larger than the base graph.

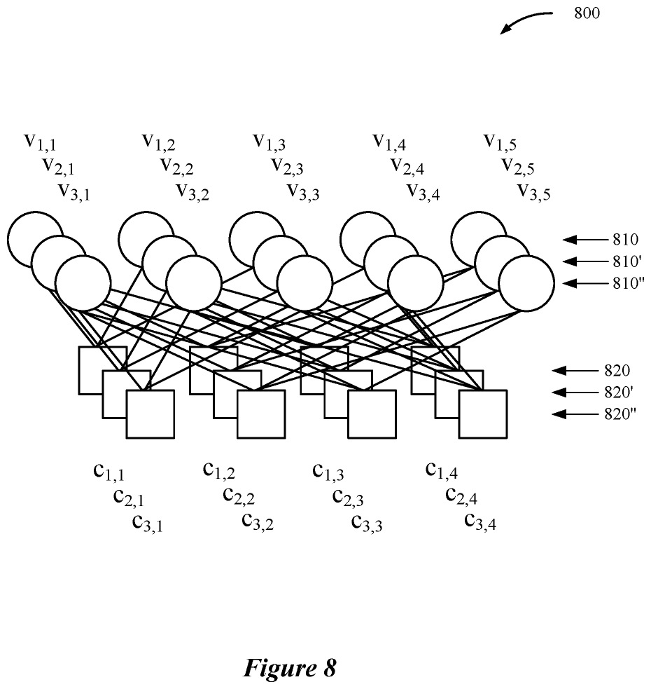

FIG. 8 is a bipartite graph 800 illustrating liftings of three copies of the bipartite graph 600 of FIG. 6. Three copies may be interconnected by permuting like edges among the copies. If the permutations are restricted to cyclic permutations, then the resulting bipartite graph 800 corresponds to a quasi-cyclic LDPC with lifting Z=3. The original graph 600 from which three copies were made is referred to herein as the base graph. To obtain graphs of different sizes, “copy and permute” operation can be applied to the base graph.

A corresponding PCM of the lifted graph can be constructed from the parity check matrix of the base graph by replacing each entry in the base parity check matrix with a Z×Z matrix. The “0” entries (those having no base edges) are replaced with the 0 matrix and the 1 entries (indicating a base edge) are replaced with a Z×Z permutation matrix. In the case of cyclic liftings, the permutations are cyclic permutations.

A cyclically lifted LDPC code can also be interpreted as a code over the ring of binary polynomials modulo x²+1. In this interpretation, a binary polynomial, (x)=b₀+b₁x+b₂x²+ . . . +b_{z-1}x¹⁻¹ may be associated to each variable node in the base graph. The binary vector (b₀, b₁, b₂, . . . , b_{z-1}) corresponds to the bits associated to Z corresponding variable nodes in the lifted graph, that is, Z copies of a single base variable node. A cyclic permutation by k (referred to as a lifting value associated to the edges in the graph) of the binary vector is achieved by multiplying the corresponding binary polynomial by x^{k} where multiplication is taken modulo x²+1. A degree d parity check in the base graph can be interpreted as a linear constraint on the neighboring binary polynomials B₁ (x), . . . , B_{d}(x), written as x^{k}^{₁}B₁ (x)+x^{k}^{₂} B₂ (x)+ . . . +x^{k}^{_{d}}B_{d}(x)=0x^{k}^{₁}B₁(x)+x^{k}^{₂}B₂ (x)+ . . . +x^{k}^{_{d}}B_{d} (x)=0, the values, k₁, . . . , k_{d} are the cyclic lifting values associated to the corresponding edges.

This resulting equation is equivalent to the Z parity checks in the cyclically lifted Tanner graph corresponding to the single associated parity check in the base graph. Thus, the parity check matrix for the lifted graph can be expressed using the matrix for the base graph in which 1 entries are replaced with monomials of the form x^{k} and 0 entries are lifted as 0, but now the 0 is interpreted as the 0 binary polynomial modulo x^{z}+1. Such a matrix may be written by giving the value k in place of x^{k}. In this case the 0 polynomial is sometimes represented as “−1” and sometimes as another character in order to distinguish it from x⁰.

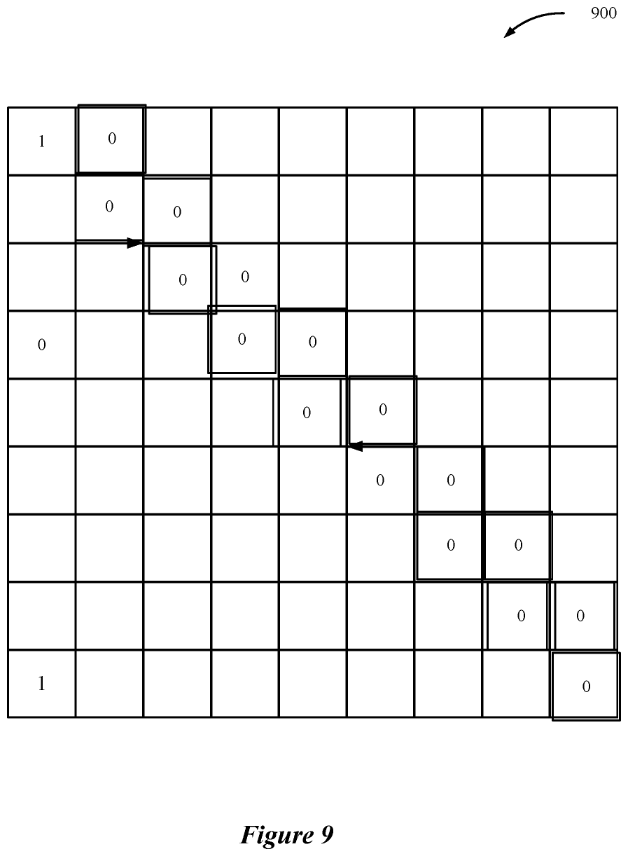

Typically, a square submatrix of the parity check matrix represents the parity bits of the code. The complementary columns correspond to information bits that, at the time of encoding, are set equal to the information bits to be encoded. The encoding may be achieved by solving for the variables in the aforementioned square submatrix in order to satisfy the parity check equations. The parity check matrix H may be partitioned into two parts M and N where M is the square portion. Thus, encoding reduces to solving M_{c}=s=Nd where c and d comprise x. In the case of quasi-cyclic codes, or cyclically lifted codes, the above algebra can be interpreted as being over the ring of binary polynomials modulo x^{z}+1. In the case of the 802.11 LDPC codes, which are quasi-cyclic, the encoding submatrix M has an integer representation as shown in a diagram 900 of FIG. 9.

A received LDPC code word can be decoded to produce a reconstructed version of the original code word. In the absence of errors, or in the case of correctable errors, decoding can be used to recover the original data unit that was encoded. Redundant bits may be used by decoders to detect and correct bit errors. LDPC decoder(s) generally operate by iteratively performing local calculations and passing those results by exchanging messages within the bipartite graph along the edges, and updating these messages by performing computations at the nodes based on the incoming messages. These steps may be repeated several times. For example, each variable node 610 in the graph 600 may initially be provided with a “soft bit” (e.g., representing the received bit of the code word) that indicates an estimate of the associated bit's value as determined by observations from the communications channel. Using these soft bits the LDPC decoders may update messages by iteratively reading them, or some portion thereof, from memory and writing an updated message, or some portion thereof, back to, memory. The update operations are typically based on the parity check constraints of the corresponding LDPC code. In implementations for lifted LDPC codes, messages on like edges are often processed in parallel.

LDPC codes designed for high speed applications often use quasi-cyclic constructions with large lifting factors and relatively small base graphs to support high parallelism in encoding and decoding operations. LDPC codes with higher code rates (e.g., the ratio of the message length to the codeword length) tend to have relatively fewer parity checks. If the number of base parity checks is smaller than the degree of a variable node (e.g., the number of edges connected to a variable node), then, in the base graph, that variable node is connected to at least one of the base parity checks by two or more edges (e.g., the variable node may have a “double edge”). If the number of base parity checks is smaller than the degree of a variable node (e.g., the number of edges connected to a variable node), then, in the base graph, that variable node is connected to at least one of the base parity checks by two or more edges. Having a base variable node and a base check node connected by two or more edges is generally undesirable for parallel hardware implementation purposes. For example, such double edges may result in multiple concurrent read and write operations to the same memory locations, which in turn may create data coherency problems. A double edge in a base LDPC code may trigger parallel reading of the same soft bit value memory location twice during a single parallel parity check update. Thus, additional circuitry is typically needed to combine the soft bit values that are written back to memory, so as to properly incorporate both updates. Eliminating double edges in the LDPC code helps to avoid this extra complexity.

LDPC code designs based on cyclic lifting can be interpreted, as codes over the ring of polynomials modulo may be binary polynomials modulo x^{Z}-1, where Z is the lifting size (e.g., the size of the cycle in the quasi-cyclic code). Thus encoding such codes can often be interpreted as an algebraic operation in this ring.

In the definition of standard irregular LDPC code ensembles (degree distributions) all edges in the Tanner graph representation may be statistically interchangeable. In other words, there exists a single statistical equivalence class of edges. A more detailed discussion of lifted LDPC codes may be found, for example, in the book titled, “Modern Coding Theory,” published Mar. 17, 2008, by Tom Richardson and Ruediger Urbanke. For multi-edge LDPC codes, multiple equivalence classes of edges may be possible. While in the standard irregular LDPC ensemble definition, nodes in the graph (both variable and constraint) are specified by their degree, i.e., the number of edges they are connected to, in the multi-edge type setting an edge degree is a vector; it specifies the number of edges connected to the node from each edge equivalence class (type) independently. A multi-edge type ensemble is comprised of a finite number of edge types. The degree type of a constraint node is a vector of (non-negative) integers; the i-th entry of this vector records the number of sockets of the i-th type connected to such a node. This vector may be referred to as an edge degree. The degree type of a variable node has two parts although it can be viewed as a vector of (non-negative) integers. The first part relates to the received distribution and will be termed the received degree and the second part specifies the edge degree. The edge degree plays the same role as for constraint nodes. Edges are typed as they pair sockets of the same type. The constraint that sockets must pair with sockets of like type characterizes the multi-edge type concept. In a multi-edge type description, different node types can have different received distributions (e.g., the associated bits may go through different channels).

Puncturing is the act of removing bits from a codeword to yield a shorter codeword. Thus, punctured variable nodes correspond to codeword bits that are not actually transmitted. Puncturing a variable node in an LDPC code creates a shortened code (e.g. due to the removal of a bit), while also effectively removing a check node. Specifically, for a matrix representation of an LDPC code, including bits to be punctured, where the variable node to be punctured has a degree of one (such a representation may be possible through row combining provided the code is proper), puncturing the variable node removes the associated bit from the code and effectively removes its single neighboring check node from the graph. As a result, the number of check nodes in the graph is reduced by one.

In current wireless systems (e.g., 5G NR), there are two types of base graphs to select from. As explained above, a base graph generally refers to a matrix with entries that can be further expanded based on an expansion factor Zc. Constructing the LDCP parity check matrix for a given information block size K and code rate R=K/N, may be as follows. One of the base graphs (BG1 or BG2) may be selected for a given combination of K and R. After base graph selection, a base matrix expansion factor Zc may be determined (e.g., by selecting a minimum Zc value in a table, such that Kb×Zc≥K). After Zc is determined, a corresponding shift coefficient matrix set can be selected from a table. Etries values in the base matrix can be determined based on the Zc, with a shifting coefficient value P(i,j) calculated by a modular Z operation:

$$P ( i , j ) = f ( Vi , j , z ) = mod ( Vi , j , z ) ,$$

where values could be looked up from tables. Finally, each entry in the final exponent matrix can be replaced with the corresponding circulant permutation matrix or zero matrix. The LDPC code construction is completed and a parity check matrix H is obtained.

### Example Use of Longer Low-Density Parity Check (LDPC) Code Signaling in Ultra High Reliability (UHR) System

Aspects of the present disclosure provide apparatuses, methods, processing systems, and computer-readable mediums for managing long low-density parity check (LDPC) codewords in ultra high reliability (UHR) systems.

As Wi-Fi applications evolve, their demand for higher data rate, lower latencies and higher reliability connection also continuously increases. For latency sensitive applications, UHR systems may provide improvements in terms of maximum latency and jitter compared to other systems. For example, the UHR systems may provide a reliable Wi-Fi connection with the lower latencies by supporting multiple wireless devices or nodes coordination and transmission. For example, with the multi-device coordination and transmission, multiple independent wireless devices may be able to coordinate their transmission parameters (e.g., transmission power, transmission frequency) such that their transmissions do not interfere with each other and thereby providing a reliable connection.

In some cases, a protocol such as a hybrid automatic repeat request (HARQ) protocol may support various signaling between transmitter and receiver devices or nodes as well as signaling between a physical (PHY) and medium access control (MAC) layers to improve retransmission operations. HARQ uses a combination of error detection and error correction techniques. For example, a HARQ transmission may include error checking bits that are added to data to be transmitted using an error-detecting (ED) code, such as a cyclic redundancy check (CRC). The error checking bits may be used by the receiver device to determine (or check) if the receiver device has properly decoded the received HARQ transmission. In some examples, original data (e.g., information bits) to be transmitted may be encoded with an error correcting code, such as a LDPC codeword using a LDPC coding scheme that systematically encodes the information bits to produce parity bits. The transmitter device may transmit both the original information bits as well as the parity bits in the HARQ transmission to the receiver device. The receiver device may be able to use the parity bits to correct errors in the information bits, thus avoiding a retransmission.

Currently, the wireless devices and the LDPC coding scheme support the use of small codeword lengths for LDPC codewords. For example, the LDPC coding scheme may support the codeword lengths of 648, 1296, and 1944 bits for the LDPC codewords. These codeword lengths are generally supported when an LDPC-based encoding is supported.

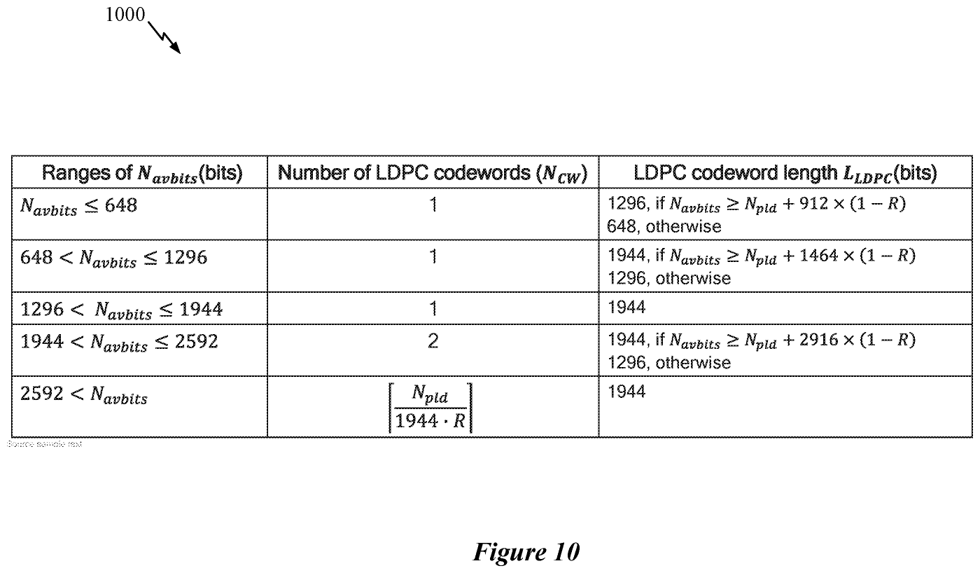

A method for selection of a length of a LDPC codeword may be based on (or depend on) rules associated with a table 1000 of FIG. 10 (e.g., before potential N_{avbits} updates when an extra orthogonal frequency division multiplexing (OFDM) symbol segment is added). In the table 1000, N_{pld} indicates a number of payload bits. An initial number of symbols is associated with (or based on) the number of payload bits and a number of data bits per symbol. N_{avbits} indicates a number of available bits. The number of available bits is associated with (or based on) the initial number of symbols, a last symbol boundary, and/or a number of coded bits per symbol.

In some cases, a long LDPC codeword (e.g., with a codeword length of 2x1944 or 4x1944 bits) may be needed. In general, the use of the longer codeword lengths for the LDPC codewords is not supported by the wireless devices. Only under certain situations, some of the wireless devices may provide limited support for the use of the longer codeword lengths for the LDPC codewords. So, when a wireless device may want to use long LDPC codewords during encoding of a data packet, the wireless device may need to communicate with other wireless devices regarding the possible usage of the long LDPC codewords (e.g., to check if these other wireless devices can provide any support for the usage and processing of the long LDPC codewords at their end).

Techniques described herein may enable a wireless device to use a long LDPC codeword. To decide if the long LDPC codeword can be used, a transmitter device (e.g., for regular transmissions) or a receiver device (e.g., for trigger-based transmissions) may determine (or obtain information indicating) whether both the transmitter device and the receiver device may support use and processing of the long LDPC codeword and that some other conditions have also been satisfied.

In some aspects, the transmitter device may indicate use (or possible use) of a longer LDPC codeword to other receiver devices via a combination of a codeword length look up table, capability information indicating support for the use of the long LDPC codeword, and other conditions. In some cases, a special field may be defined in a PHY header to indicate whether 2x1944 or 4x1944 bits LDPC codeword has been used by the transmitter device in encoding.

In certain aspects, a wireless device or node (e.g., the AP 102 or the STA 104 depicted and described with respect to FIG. 1) may include multiple antennas to transmit and receive wireless communications. The wireless device may also include at least one processor (e.g., an application processor, a transmit processor, a receive processor, etc.) and at least one memory coupled with the at least one processor. The wireless device further includes at least one external network interface that enables the wireless device to communicate with a core network or a backhaul network to gain access to external networks including the Internet. The external network interface may include one or both of a wired (for example, Ethernet) network interface and a wireless network interface. Each of the aforementioned components of the wireless device can communicate with other components of the wireless device directly or indirectly, over at least one bus.

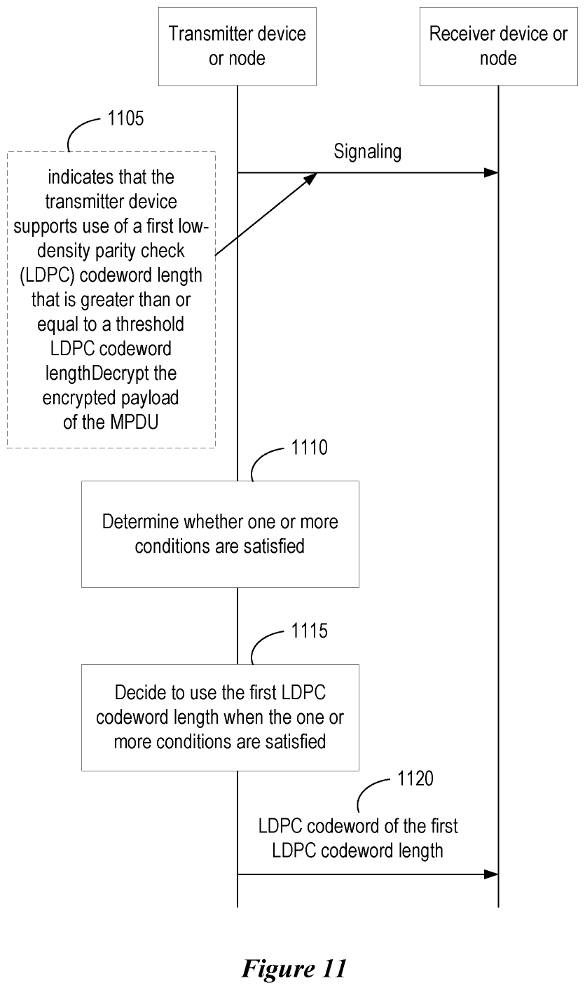

Some aspects of the subject matter described in this disclosure may be further understood with reference to FIGS. 11-19.

FIG. 11 shows a call flow diagram illustrating example communication among wireless devices (such as wireless nodes) for managing long LDPC codewords in UHR systems. The wireless devices may include a transmitter device and a receiver device to transmit and receive wireless communications. The transmitter device may be an AP (e.g., such as the AP 102 depicted and described with respect to FIG. 1) or a STA (e.g., such as the STA 104 depicted and described with respect to FIG. 1). The receiver device may be an AP (e.g., such as the AP 102 depicted and described with respect to FIG. 1) or a STA (e.g., such as the STA 104 depicted and described with respect to FIG. 1).

As indicated at 1105, the transmitter device transmits signaling to the receiver device indicating that the transmitter device supports use of a first LDPC codeword length that is greater than or equal to a threshold LDPC codeword length (e.g., supports use of a long LDPC codeword).

In certain aspects, the receiver device (e.g., in view of the received signaling) may transmit capability information of the receiver device to the transmitter device. The capability information of the receiver device may indicate that the receiver device also supports use of the long LDPC codeword.

In some aspects, the receiver device may transmit the capability information of the receiver device to the transmitter device at any time (e.g., prior to receiving the signaling from the transmitter device).

As indicated at 1110, the transmitter device determines (or obtains information indicating) whether one or more conditions have been satisfied (or met). The conditions are associated with (or based on) the capability information of the receiver device, a bandwidth value, a resource unit (RU) size, a multiple RU (MRU) size, a modulation coding scheme (MCS) level, a number of spatial streams, a number of coded bits per orthogonal frequency division multiplexing (OFDM) symbol, a number of data bits per OFDM symbol, and/or one or more frequency bands for at least one of transmission or reception operations. In some aspects, some of the conditions may be associated with (or based on) certain implementation features associated with the transmitter device.

In certain aspects, the transmitter device may determine (or conclude based on the obtained information) that at least one condition has been satisfied when both the transmitter device and the receiver device may support the use of the long LDPC codeword.

In certain aspects, the transmitter device may determine (or conclude based on the obtained information) that at least one condition has been satisfied when the bandwidth value is greater than or equal to a bandwidth threshold.

In certain aspects, the transmitter device may determine (or conclude based on the obtained information) that at least one condition has been satisfied when the RU size is greater than or equal to an RU size threshold. For example, the transmitter device may determine that one condition has been satisfied when the RU size is greater than 996 tones.

In certain aspects, the transmitter device may determine (or conclude based on the obtained information) that at least one condition has been satisfied when the MRU size is greater than or equal to an MRU size threshold.

In certain aspects, the transmitter device may determine (or conclude based on the obtained information) that at least one condition has been satisfied when the MCS level is greater than or equal to an MCS threshold. For example, the transmitter device may determine that one condition has been satisfied when the MCS level is greater than MCS7.

In certain aspects, the transmitter device may determine (or conclude based on the obtained information) that at least one condition has been satisfied when the number of spatial streams is greater than or equal to a spatial stream threshold. For example, the transmitter device may determine one condition has been satisfied when the number of spatial streams is greater than or equal to two spatial streams.

In certain aspects, the transmitter device may determine (or conclude based on the obtained information) that at least one condition has been satisfied when the number of coded bits per OFDM symbol is greater than or equal to a coded bit threshold. For example, the transmitter device may determine that one condition has been satisfied when the number of coded bits per OFDM symbol is greater than three thousand.

In certain aspects, the transmitter device may determine (or conclude based on the obtained information) that at least one condition has been satisfied when the number of data bits per OFDM symbol is greater than or equal to a data bit threshold.

In certain aspects, the transmitter device may determine that at least one condition has been satisfied when the transmitter device may support the one or more frequency bands for the at least one of transmission or reception operations. In one example, the transmitter device may determine that the at least one condition has been satisfied when the transmitter device may support the one or more frequency bands for new radio (NR) operations. In another example, the transmitter device may determine that the at least one condition has been satisfied when the transmitter device may support the one or more frequency bands for 2.4G, 5G and/or 6G operations.

In certain aspects, the transmitter device may determine that at least one condition has been satisfied when the receiver device may support the one or more frequency bands for the at least one of transmission or reception operations. In one example, the transmitter device may determine that the at least one condition has been satisfied when the receiver device may support the one or more frequency bands for the NR operations. In another example, the transmitter device may determine that the at least one condition has been satisfied when the receiver device may support the one or more frequency bands for the 2.4G, 5G and/or 6G operations.

As indicated at 1115, the transmitter device decides to use the first LDPC codeword length (i.e. the long LDPC codeword). In one aspect, the transmitter device may decide to use the long LDPC codeword when the transmitter device may determine that at least one condition has been satisfied.

In another aspect, the transmitter device may decide to use the long LDPC codeword when the transmitter device may determine (or conclude based on the obtained information) that at least two conditions have been satisfied. For example, the transmitter device may decide to use the long LDPC codeword when both the transmitter device and the receiver device may support the use of long LDPC codewords, and the RU size is greater than 996 tones.

In another example, the transmitter device may decide to use the long LDPC codeword when both the transmitter device and the receiver device may support the use of long LDPC codewords, and the MCS level is greater than MCS7.

In yet another example, the transmitter device may decide to use the long LDPC codeword when both the transmitter device and the receiver device may support the use of long LDPC codewords, and the number of spatial streams is greater than or equal to two spatial streams.

As indicated at 1120, the transmitter device transmits an LDPC codeword of the first LDPC codeword length (e.g., the long LDPC codeword) to the receiver device.

In certain aspects, the transmitter device may determine (or calculate) a value of the first LDPC codeword length of the long LDPC codeword based on (or using) a number of available bits for the transmitter device. For example, the long LDPC codeword may be transmitted/used based on the number of available bits using a logic corresponding to Wi-Fi codeword selection.

In certain aspects, the transmitter device may calculate the number of available bits based on (or using) a data packet length.

In certain aspects, the transmitter device may calculate the number of available bits based on (or using) an initial number of symbols.

In certain aspects, the transmitter device may calculate the number of available bits based on (or using) a last symbol boundary in the initial number of symbols.

In certain aspects, the transmitter device may calculate the number of available bits based on (or using) a number of coded bits per symbol in the initial number of symbols.

In certain aspects, the transmitter device may calculate the number of available bits based on (or using) the data packet length, the initial number of symbols, the last symbol boundary in the initial number of symbols, and/or the number of coded bits per symbol in the initial number of symbols.

In certain aspects, the transmitter device may transmit an indication of the first LDPC codeword length of the long LDPC codeword to the receiver device.

In one aspect, the indication of the first LDPC codeword length of the long LDPC codeword may be conveyed via a physical layer (PHY) header to the receiver device. For example, a field (such as per-user information field) may be defined in the PHY header to indicate whether 2x (2x1944) or 4x (4x1944) LDPC codeword was used in encoding.

In another aspect, the indication of the first LDPC codeword length of the long LDPC codeword may be conveyed via a signal (SIG) field to the receiver device. For example, a user specific SIG field may be used to indicate whether 2x (2x1944) or 4x (4x1944) LDPC codeword was used/transmitted.

In another aspect, the indication of the first LDPC codeword length of the long LDPC codeword may include one bit in the PHY header to the receiver device. The one bit may indicate whether 2x (2x1944) or 4x (4x1944) LDPC codeword was used/supported.

In another aspect, the indication of the first LDPC codeword length of the long LDPC codeword may include two bits in the PHY header to the receiver device. The two bits may indicate that both 2x (2x1944) and 4x (4x1944) LDPC codes were used/or are supported.

In certain aspects, the indication of the first LDPC codeword length of the long LDPC codeword based on or using one bit may correspond to a first value of the first LDPC codeword length of the long LDPC codeword. In one example, the PHY header may include one bit which may indicate the first value of the first LDPC codeword length of the long LDPC codeword. In another example, the SIG field may include one bit which may indicate the first value of the first LDPC codeword length of the long LDPC codeword.

In certain aspects, the indication of the first LDPC codeword length of the long LDPC codeword based on or using two bits may correspond to a second value of the first LDPC codeword length of the long LDPC codeword. In one example, the PHY header may include two bits which may indicate the second value of the first LDPC codeword length of the long LDPC codeword. In another example, the SIG field may include two bits which may indicate the second value of the first LDPC codeword length of the long LDPC codeword.

In certain aspects, the transmitter device may dynamically transmit signaling to the receiver device indicating that the transmitter device has turned on or off the use of the long LDPC codeword for one or more data packets (or per-packet basis).

In certain aspects, the receiver device may dynamically transmit signaling to the transmitter device indicating that the receiver device has turned on or off the use of the long LDPC codeword for one or more data packets (or per-packet basis).

In certain aspects, the transmitter device may always use the long LDPC codeword when the one or more conditions are satisfied. In certain aspects, the transmitter device may be able switch on or off the use of the long LDPC codeword on a per-packet basis even when the one or more conditions are satisfied.

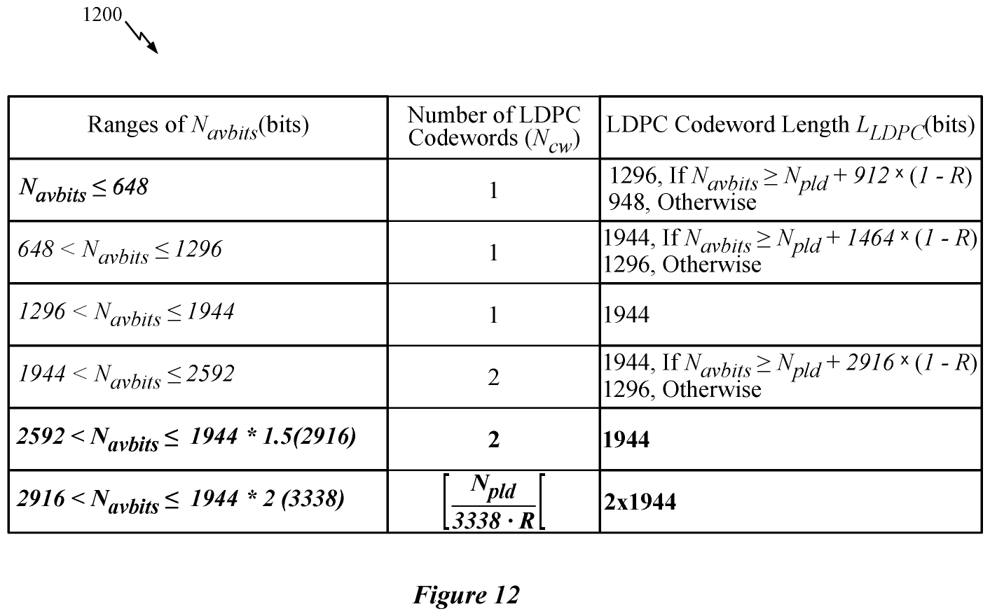

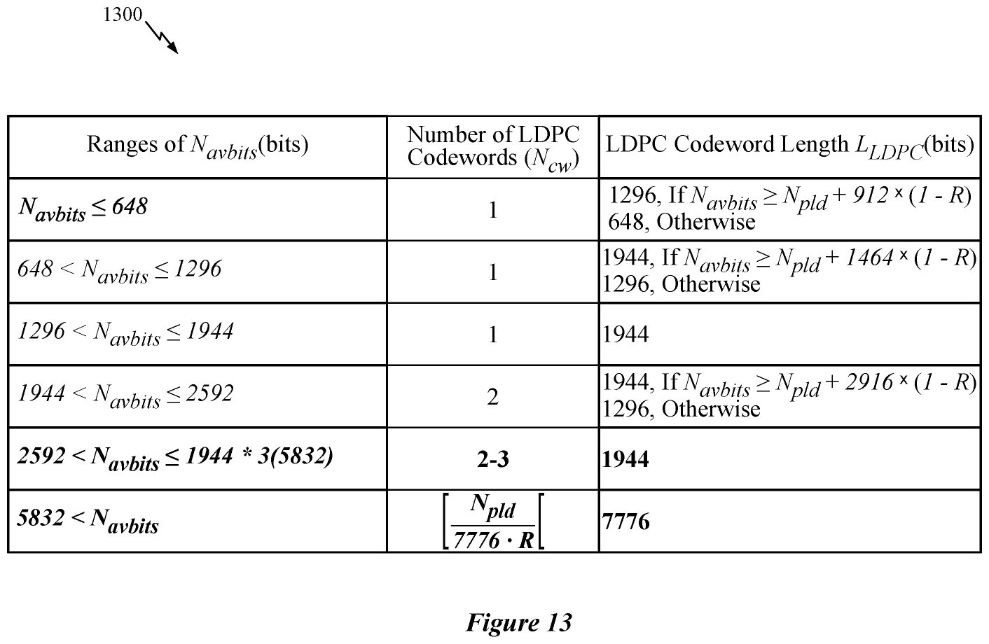

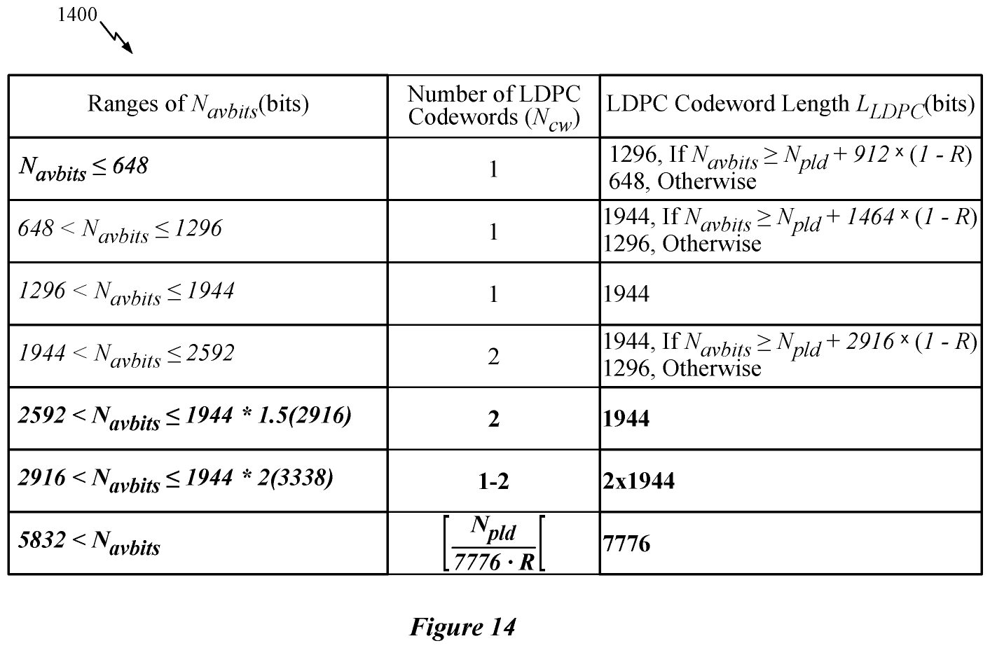

In certain aspects, the transmitter device may determine (or decide) to use the long LDPC codeword. In one example, the transmitter device may determine or select a length of a LDPC codeword based on a table 1200 of FIG. 12 (e.g., when 2x1944 bits LDPC codes are there and up to two codewords with length less than 2x1944 bits can be used in a packet). In another example, the transmitter device may determine or select a length of a LDPC codeword based on a table 1300 of FIG. 13 (e.g., when 4x1944 bits LDPC codes are there and up to three codewords with length less than 4x1944 bits can be used in a packet). In another example, the transmitter device may select a length of a LDPC codeword based on a table 1400 of FIG. 14 (e.g., when 2x1944 and 4x1944 bits LDPC codes are there and up to two codewords with length less than 4x1944 bits can be used in a packet).

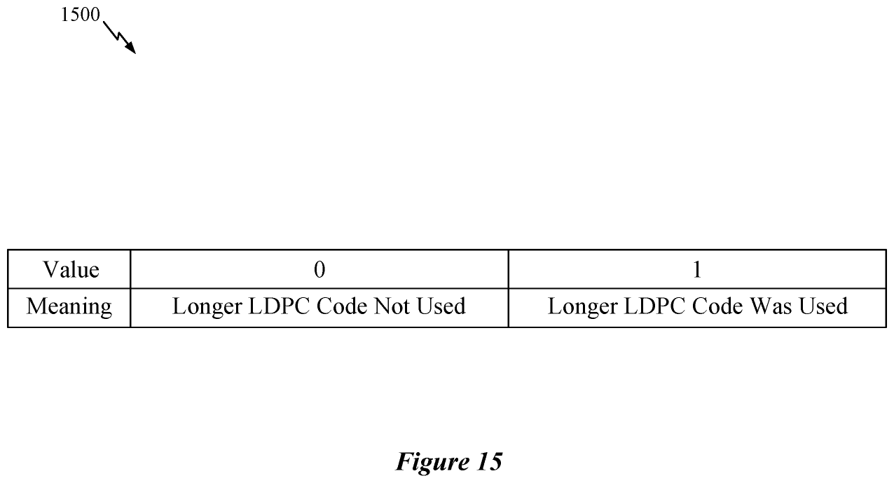

In certain aspects, when 2x1944 or 4x1944 bits LDPC codes are there or have been introduced, the transmitter device may include at least one bit in a PHY header (as illustrated in a diagram 1500 of FIG. 15) to indicate whether the long LDPC codeword has been used or not by the transmitter device. For example, a first bit (zero) may indicate that the long LDPC codeword has not been used and a second bit (one) may indicate that the long LDPC codeword has been used.

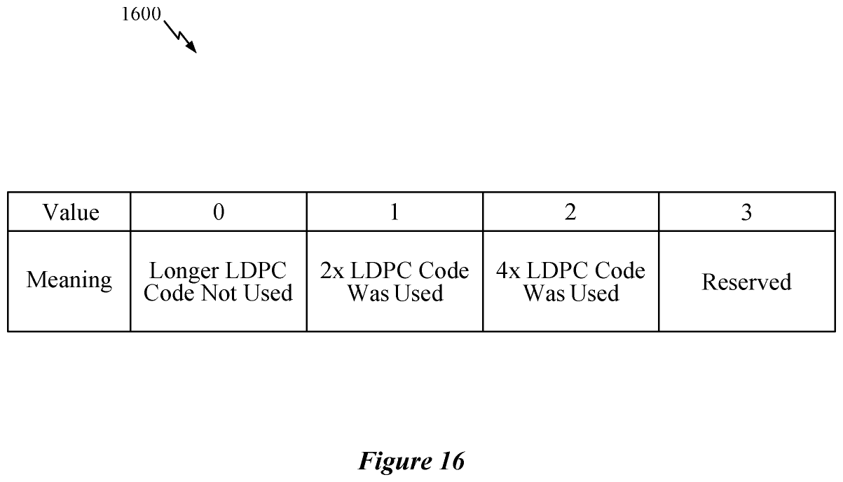

In certain aspects, when 2x1944 and 4x1944 bits LDPC codes are there or have been introduced, the transmitter device may include at least one bit in a PHY header (as illustrated in a diagram 1600 of FIG. 16) to indicate whether (and which) long LDPC codeword has been used or not by the transmitter device. For example, a first bit (zero) may indicate that the long LDPC codeword has not been used, a second bit (one) may indicate that 2x1944 bits LDPC codeword has been used, a second bit (three) may indicate that 4x1944 bits LDPC codeword has been used, and a fourth bit (three) may indicate reservation status.

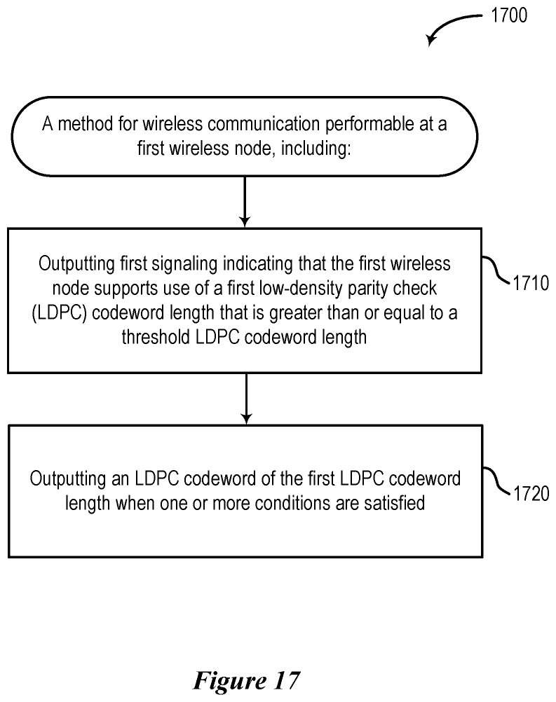

FIG. 17 shows a flowchart illustrating a process or method 1700 performable at a first wireless node (e.g., a transmitter node or device), according to some aspects of the present disclosure.

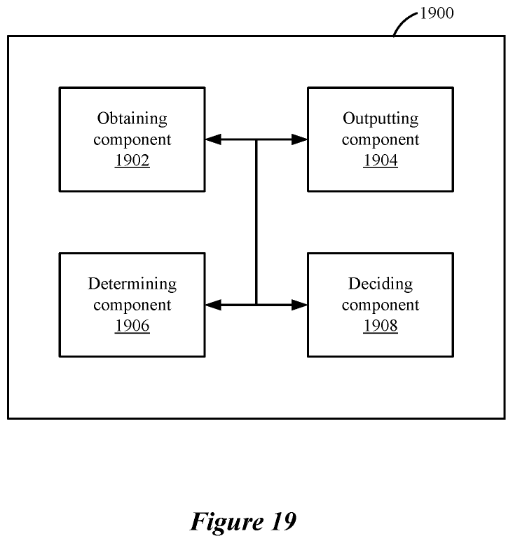

In certain aspects, the operations of the process 1700 may be implemented by the first wireless node such as a wireless AP or its components as described herein. For example, the process 1700 may be performed by a wireless communication device, such as a wireless communication device 1900 described with reference to FIG. 19, operating as or within the wireless AP. In some examples, the process 1700 may be performed by the wireless AP, such as one of the wireless APs 102 described with reference to FIG. 1.

In certain aspects, the operations of the process 1700 may be implemented by the first wireless node such as a wireless STA or its components as described herein. For example, the process 1700 may be performed by a wireless communication device, such as the wireless communication device 1900 described with reference to FIG. 19, operating as or within the wireless STA. In some examples, the process 1700 may be performed by the wireless STA such as one of the STAs 104 described with reference to FIG. 1.

At 1710, the process 1700 includes the first wireless node outputting (e.g., for transmission) first signaling indicating that the first wireless node supports use of a first LDPC codeword length that is greater than or equal to a threshold LDPC codeword length.

At 1720, the process 1700 includes the first wireless node outputting (e.g., for transmission) an LDPC codeword of the first LDPC codeword length when one or more conditions are satisfied.

In certain aspects, the one or more conditions are associated with (or based on) at least one of: capability information of a second wireless node, bandwidth value, RU size, MRU size, MCS level, a number of spatial streams, a number of coded bits per OFDM symbol, a number of data bits per OFDM symbol, or one or more frequency bands for at least one of transmission or reception operations.

In certain aspects, the process 1700 includes the first wireless node obtaining the capability information that indicates that the second wireless node supports use of the first LDPC codeword length that is greater than or equal to the threshold LDPC codeword length.

In certain aspects, the one or more conditions are satisfied when the second wireless node indicates support for use of the first LDPC codeword length that is greater than or equal to the threshold LDPC codeword length.

In certain aspects, the one or more conditions are satisfied when the bandwidth value is greater than or equal to a bandwidth threshold.

In certain aspects, the one or more conditions are satisfied when the RU size is greater than or equal to an RU size threshold.

In certain aspects, the one or more conditions are satisfied when the MRU size is greater than or equal to an MRU size threshold.

In certain aspects, the one or more conditions are satisfied when the MCS level is greater than or equal to an MCS threshold.

In certain aspects, the one or more conditions are satisfied when the number of spatial streams is greater than or equal to a spatial stream threshold.

In certain aspects, the one or more conditions are satisfied when the number of coded bits per OFDM symbol is greater than or equal to a coded bit threshold.

In certain aspects, the one or more conditions are satisfied when the number of data bits per OFDM symbol is greater than or equal to a data bit threshold.

In certain aspects, a value of the first LDPC codeword length is associated with (or based on) a quantity of available bits for the first wireless node. The quantity of available bits is associated with (or based on) at least one of a data packet length, an initial quantity of symbols, a last symbol boundary in the initial quantity of symbols, or a quantity of coded bits per symbol in the initial quantity of symbols.

In certain aspects, the process 1700 includes the first wireless node outputting (e.g., for transmission) an indication of the first LDPC codeword length.

In certain aspects, the indication of the first LDPC codeword length is outputted (e.g., for transmission) via a PHY header.

In certain aspects, the indication of the first LDPC codeword length is outputted (e.g., for transmission) via a SIG field.

In certain aspects, the indication of the first LDPC codeword length includes one bit and corresponds to a first value of the first LDPC codeword length or the indication of the first LDPC codeword length includes two bits and corresponds to a second value of the first LDPC codeword length.

In certain aspects, the process 1700 includes the first wireless node outputting (e.g., for transmission) second signaling indicating that the first wireless node has turned off the use of the LDPC codeword length that is greater than or equal to the threshold LDPC codeword length.

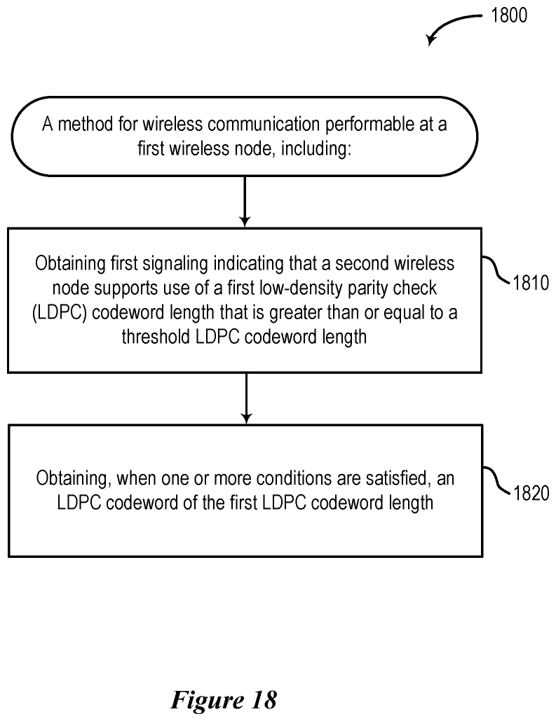

FIG. 18 shows a flowchart illustrating a process or method 1800 performable at a first wireless node (e.g., a receiver node or device), according to some aspects of the present disclosure.

In certain aspects, the operations of the process 1800 may be implemented by the first wireless node such as a wireless AP or its components as described herein. For example, the process 1800 may be performed by a wireless communication device, such as a wireless communication device 1900 described with reference to FIG. 19, operating as or within the wireless AP. In some examples, the process 1800 may be performed by the wireless AP, such as one of the wireless APs 102 described with reference to FIG. 1.

In certain aspects, the operations of the process 1800 may be implemented by the first wireless node such as a wireless STA or its components as described herein. For example, the process 1800 may be performed by a wireless communication device, such as the wireless communication device 1900 described with reference to FIG. 19, operating as or within the wireless STA. In some examples, the process 1800 may be performed by the wireless STA such as one of the STAs 104 described with reference to FIG. 1.

At 1810, the process 1800 includes the first wireless node obtaining first signaling indicating that a second wireless node supports use of a first LDPC codeword length that is greater than or equal to a threshold LDPC codeword length when one or more conditions are satisfied.

At 1820, the process 1800 includes the first wireless node obtaining, when one or more conditions are satisfied, an LDPC codeword of the first LDPC codeword length.

In certain aspects, the one or more conditions are associated with (or based on) at least one of: capability information of the first wireless node, bandwidth value, RU size, MRU size, MCS level, a number of spatial streams, a number of coded bits per OFDM symbol, a number of data bits per OFDM symbol, or one or more frequency bands for at least one of transmission or reception operations.

In certain aspects, the process 1800 includes the first wireless node outputting (e.g., for transmission) the capability information indicating that the first wireless node supports use of the first LDPC codeword length that is greater than or equal to the threshold LDPC codeword length.

In certain aspects, the process 1800 includes the first wireless node obtaining an indication of the first LDPC codeword length.

In certain aspects, the indication of the first LDPC codeword length is obtained via a PHY header.

In certain aspects, the indication of the first LDPC codeword length is obtained via a SIG field.

In certain aspects, the indication of the first LDPC codeword length includes one bit and corresponds to a first value of the first LDPC codeword length or the indication of the first LDPC codeword length includes two bits and corresponds to a second value of the first LDPC codeword length.

In certain aspects, the process 1800 includes the first wireless node obtaining second signaling indicating that the second wireless node has turned off the use of the LDPC codeword length that is greater than or equal to the threshold LDPC codeword length.

### Example Wireless Communication Device

FIG. 19 shows a block diagram of a wireless communication device 1900, according to some aspects of the present disclosure. In one example, the wireless communication device 1900 is configured or operable to perform a process 1700 described with reference to FIG. 17. In another example, the wireless communication device 1900 is configured or operable to perform a process 1800 described with reference to FIG. 18.

The wireless communication device 1900 may include one or more chips, SoCs, chipsets, packages, components or devices that individually or collectively constitute or comprise a processing system. The processing system may interface with other components of the wireless communication device 1900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1900 may transmit the information output from the chip. In such an example, the second interface may refer to an interface between the processing system of the chip and a reception component, such that the device 1900 may receive information that is then passed to the processing system. In some such examples, the first interface also may obtain information, such as from the transmission component, and the second interface also may output information, such as to the reception component.

The processing system of the wireless communication device 1900 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1900 can be a device such as AP 102 described with reference to FIG. 1. In some other examples, the wireless communication device 1900 can be an AP that includes a processing system and other components including multiple antennas. The wireless communication device 1900 is capable of transmitting and receiving wireless communications in the form of, for example, wireless packets. For example, the wireless communication device 1900 can be configurable or configured to transmit and receive packets in the form of physical layer PPDUs and MPDUs conforming to one or more of the IEEE 802.11 family of wireless communication protocol standards. In some other examples, the wireless communication device 1900 can be configurable or configured to transmit and receive signals and communications conforming to one or more 3GPP specifications including those for 5G NR or 6G. In some examples, the wireless communication device 1900 also includes or can be coupled with one or more application processors which may be further coupled with one or more other memories. In some examples, the wireless communication device 1900 further includes at least one external network interface coupled with the processing system that enables communication with a core network or backhaul network that enables the wireless communication device 1900 to gain access to external networks including the Internet.

In some examples, the wireless communication device 1900 can be a device such as STA 104 described with reference to FIG. 1. In some examples, the wireless communication device 1900 further includes a user interface (UI) (such as a touchscreen or keypad) and a display, which may be integrated with the UI to form a touchscreen display. In some examples, the wireless communication device 1900 may further include one or more sensors such as, for example, one or more inertial sensors, accelerometers, temperature sensors, pressure sensors, or altitude sensors.

The wireless communication device 1900 includes obtaining component 1902, outputting component 1904, determining component 1906, and/or deciding component 1908. Portions of one or more of the components 1902, 1904, 1906, 1908 may be implemented at least in part in hardware or firmware. For example, the obtaining component 1902 and the outputting component 1904 may be implemented at least in part by a modem. In some examples, at least some of the components 1902, 1904, 1906, 1908 are implemented at least in part by at least one processor and as software stored in a memory. For example, portions of one or more of the components 1902, 1904, 1906, 1908 can be implemented as non-transitory instructions (or “code”) executable by the processor to perform the functions or operations of the respective module.

The obtaining component 1902 may be capable of, is configurable or configured to, or operable to at least obtain signaling indicating that a wireless node supports use of a first LDPC codeword length that is greater than or equal to a threshold LDPC codeword length, and an LDPC codeword of the first LDPC codeword length when one or more conditions are satisfied.

The outputting component 1904 may be capable of, is configurable or configured to, or operable to at least output (e.g., for transmission) signaling indicating that a wireless node supports use of a first LDPC codeword length that is greater than or equal to a threshold LDPC codeword length, and an LDPC codeword of the first LDPC codeword length when one or more conditions are satisfied.

The determining component 1906 may be capable of, is configurable or configured to, or operable to at least determine whether one or more conditions are satisfied for transmitting an LDPC codeword of a first LDPC codeword length.

The deciding component 1908 may be capable of, is configurable or configured to, or operable to at least decide to transmit an LDPC codeword of a first LDPC codeword length when one or more conditions are satisfied.

Various components of the wireless communication device 1900 may provide means for performing the process 1700 described with reference to FIG. 17, the process 1800 described with reference to FIG. 18, or any aspect related to it. Means for receiving or obtaining may include transceivers and/or antenna(s) of the AP 102 or the STA 104 described with reference to FIG. 1 and/or the obtaining component 1902 of the wireless communication device 1900. Means for transmitting, sending or outputting (e.g., for transmission) may include transceivers and/or antenna(s) of the AP 102 or the STA 104 described with reference to FIG. 1 and/or the outputting component 1904 of the wireless communication device 1900. Means for determining may include one or more processors (such as a receive processor, a controller, and/or a transmit processor) of the AP 102 or the STA 104 described with reference to FIG. 1 and/or the determining component 1906 of the wireless communication device 1900. Means for deciding may include one or more processors (such as a receive processor, a controller, and/or a transmit processor) of the AP 102 or the STA 104 described with reference to FIG. 1 and/or the deciding component 1908 of the wireless communication device 1900.

In some cases, rather than actually transmitting, for example, signals and/or data, the wireless communication device 1900 may have an interface to output signals and/or data for transmission (means for outputting). For example, a processor may output signals and/or data, via a bus interface, to a radio frequency (RF) front end of the wireless communication device 1900 for transmission. In various aspects, the RF front end may include various components, including transmit and receive processors, transmit and receive MIMO processors, modulators, demodulators, and the like.

In some cases, rather than actually receiving signals and/or data, the wireless communication device 1900 may have an interface to obtain the signals and/or data received from another device (means for obtaining). For example, a processor may obtain (or receive) the signals and/or data, via a bus interface, from an RF front end of the wireless communication device 1900 for reception. In various aspects, the RF front end may include various components, including transmit and receive processors, transmit and receive MIMO processors, modulators, demodulators, and the like.

### Example Clauses

Implementation examples are described in the following numbered clauses:

Clause 1: A method for wireless communication performable at a first wireless node, comprising: outputting first signaling indicating that the first wireless node supports use of a first low-density parity check (LDPC) codeword length that is greater than or equal to a threshold LDPC codeword length; and outputting an LDPC codeword of the first LDPC codeword length when one or more conditions are satisfied.

Clause 2: The method of clause 1, wherein the one or more conditions are associated with at least one of: capability information of a second wireless node, a bandwidth value, a resource unit (RU) size, a multiple RU (MRU) size, a modulation coding scheme (MCS) level, a number of spatial streams, a number of coded bits per orthogonal frequency division multiplexing (OFDM) symbol, a number of data bits per OFDM symbol, or one or more frequency bands for at least one of transmission or reception operations.

Clause 3: The method of clause 2, further comprising obtaining the capability information that indicates that the second wireless node supports use of the first LDPC codeword length that is greater than or equal to the threshold LDPC codeword length.

Clause 4: The method of clause 3, wherein the one or more conditions are satisfied when the second wireless node indicates support for use of the first LDPC codeword length that is greater than or equal to the threshold LDPC codeword length.

Clause 5: The method of clause 2, wherein the one or more conditions are satisfied when the bandwidth value is greater than or equal to a bandwidth threshold.

Clause 6: The method of clause 2, wherein the one or more conditions are satisfied when the RU size is greater than or equal to an RU size threshold.

Clause 7: The method of clause 2, wherein the one or more conditions are satisfied when the MRU size is greater than or equal to an MRU size threshold.

Clause 8: The method of clause 2, wherein the one or more conditions are satisfied when the MCS level is greater than or equal to an MCS threshold.

Clause 9: The method of clause 2, wherein the one or more conditions are satisfied when the number of spatial streams is greater than or equal to a spatial stream threshold.

Clause 10: The method of clause 2, wherein the one or more conditions are satisfied when the number of coded bits per OFDM symbol is greater than or equal to a coded bit threshold.

Clause 11: The method of clause 2, wherein at least one of: the one or more conditions are satisfied when the number of data bits per OFDM symbol is greater than or equal to a data bit threshold or the one or more conditions are satisfied when the first wireless node supports use of the one or more frequency bands for the at least one of transmission or reception operations.

Clause 12: The method of any one of clauses 1-11, wherein a value of the first LDPC codeword length is associated with a quantity of available bits for the first wireless node, wherein the quantity of available bits is associated with at least one of a data packet length, an initial quantity of symbols, a last symbol boundary in the initial quantity of symbols, or a quantity of coded bits per symbol in the initial quantity of symbols.

Clause 13: The method of any one of clauses 1-12, further comprising outputting an indication of the first LDPC codeword length.

Clause 14: The method of clause 13, wherein the indication of the first LDPC codeword length is output via a physical layer (PHY) header.

Clause 15: The method of clause 13, wherein the indication of the first LDPC codeword length is output via a signal (SIG) field.

Clause 16: The method of clause 13, wherein the indication of the first LDPC codeword length comprises one bit and corresponds to a first value of the first LDPC codeword length or the indication of the first LDPC codeword length comprises two bits and corresponds to a second value of the first LDPC codeword length.

Clause 17: The method of any one of clauses 1-16, further comprising outputting second signaling indicating that the first wireless node has turned off the use of the LDPC codeword length that is greater than or equal to the threshold LDPC codeword length.

Clause 18: A method for wireless communication performable at a first wireless node, comprising: obtaining first signaling indicating that a second wireless node supports use of a first low-density parity check (LDPC) codeword length that is greater than or equal to a threshold LDPC codeword length when one or more conditions are satisfied; and obtaining, when one or more conditions are satisfied, an LDPC codeword of the first LDPC codeword length.

Clause 19: The method of clause 18, wherein the one or more conditions are associated with at least one of: capability information of the first wireless node, a bandwidth value, a resource unit (RU) size, a multiple RU (MRU) size, a modulation coding scheme (MCS) level, a number of spatial streams, a number of coded bits per orthogonal frequency division multiplexing (OFDM) symbol, a number of data bits per OFDM symbol, or one or more frequency bands for at least one of transmission or reception operations.

Clause 20: The method of clause 19, further comprising outputting the capability information indicating that the first wireless node supports use of the first LDPC codeword length that is greater than or equal to the threshold LDPC codeword length.

Clause 21: The method of any one of clauses 18-20, further comprising obtaining an indication of the first LDPC codeword length.

Clause 22: The method of clause 21, wherein the indication of the first LDPC codeword length is obtained via a physical layer (PHY) header.

Clause 23: The method of clause 21, wherein the indication of the first LDPC codeword length is obtained via a signal (SIG) field.

Clause 24: The method of clause 21, wherein the indication of the first LDPC codeword length comprises one bit and corresponds to a first value of the first LDPC codeword length or the indication of the first LDPC codeword length comprises two bits and corresponds to a second value of the first LDPC codeword length.

Clause 25: The method of any one of clauses 18-24, further comprising obtaining second signaling indicating that the second wireless node has turned off the use of the LDPC codeword length that is greater than or equal to the threshold LDPC codeword length.

Clause 26: An apparatus, comprising: at least one memory comprising instructions; and one or more processors, individually or collectively, configured to execute the instructions and cause the apparatus to perform a method in accordance with any one of clauses 1-25.

Clause 27: An apparatus, comprising means for performing a method in accordance with any one of clauses 1-25.

Clause 28: A non-transitory computer-readable medium comprising executable instructions that, when executed by one or more processors of an apparatus, cause the apparatus to perform a method in accordance with any one of clauses 1-25.

Clause 29: A computer program product embodied on a computer-readable storage medium comprising code for performing a method in accordance with any one of clauses 1-25.

Clause 30: An access point (AP), comprising: at least one transceiver; at least one memory comprising instructions; and one or more processors, individually or collectively, configured to execute the instructions and cause the AP to perform a method in accordance with any one of clauses 1-17, wherein the at least one transceiver is configured to transmit the first signaling and the LDPC codeword.

Clause 31: A wireless station (STA), comprising: at least one transceiver; at least one memory comprising instructions; and one or more processors, individually or collectively, configured to execute the instructions and cause the wireless STA to perform a method in accordance with any one of clauses 1-17, wherein the at least one transceiver is configured to transmit the first signaling and the LDPC codeword.

Clause 32: An access point (AP), comprising: at least one transceiver; at least one memory comprising instructions; and one or more processors, individually or collectively, configured to execute the instructions and cause the AP to perform a method in accordance with any one of clauses 18-25, wherein the at least one transceiver is configured to receive the first signaling and the LDPC codeword.

Clause 33: A wireless station (STA), comprising: at least one transceiver; at least one memory comprising instructions; and one or more processors, individually or collectively, configured to execute the instructions and cause the wireless STA to perform a method in accordance with any one of clauses 18-25, wherein the at least one transceiver is configured to receive the first signaling and the LDPC codeword.

### ADDITIONAL CONSIDERATIONS

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable sub combination. As such, although features may be described above as acting in particular combinations, and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

The invention claimed is:

1. An apparatus for wireless communication, comprising:
at least one memory comprising instructions; and
one or more processors, individually or collectively, configured to execute the instructions and cause the apparatus to:
output first signaling indicating that the apparatus supports use of a first low-density parity check (LDPC) codeword length that is greater than or equal to a threshold LDPC codeword length; and
output an LDPC codeword of the first LDPC codeword length when one or more conditions are satisfied.

2. The apparatus of claim 1, wherein the one or more conditions are associated with at least one of: capability information of a wireless node, a bandwidth value, a resource unit (RU) size, a multiple RU (MRU) size, a modulation coding scheme (MCS) level, a number of spatial streams, a number of coded bits per orthogonal frequency division multiplexing (OFDM) symbol, a number of data bits per OFDM symbol, or one or more frequency bands for at least one of transmission or reception operations.

3. The apparatus of claim 2, wherein the one or more processors are, individually or collectively, configured to execute the instructions and cause the apparatus to obtain the capability information that indicates that the wireless node supports use of the first LDPC codeword length that is greater than or equal to the threshold LDPC codeword length.

4. The apparatus of claim 3, wherein the one or more conditions are satisfied when the wireless node indicates support for use of the first LDPC codeword length that is greater than or equal to the threshold LDPC codeword length.

5. The apparatus of claim 2, wherein the one or more conditions are satisfied when the bandwidth value is greater than or equal to a bandwidth threshold.

6. The apparatus of claim 2, wherein the one or more conditions are satisfied when the RU size is greater than or equal to an RU size threshold.

7. The apparatus of claim 2, wherein the one or more conditions are satisfied when the MRU size is greater than or equal to an MRU size threshold.

8. The apparatus of claim 2, wherein the one or more conditions are satisfied when the MCS level is greater than or equal to an MCS threshold.

9. The apparatus of claim 2, wherein the one or more conditions are satisfied when the number of spatial streams is greater than or equal to a spatial stream threshold.

10. The apparatus of claim 2, wherein the one or more conditions are satisfied when the number of coded bits per OFDM symbol is greater than or equal to a coded bit threshold.

11. The apparatus of claim 2, wherein at least one of:
the one or more conditions are satisfied when the number of data bits per OFDM symbol is greater than or equal to a data bit threshold; or
the one or more conditions are satisfied when the apparatus supports use of the one or more frequency bands for the at least one of transmission or reception operations.

12. The apparatus of claim 1, wherein a value of the first LDPC codeword length is associated with a quantity of available bits for the apparatus, wherein the quantity of available bits is associated with at least one of a data packet length, an initial quantity of symbols, a last symbol boundary in the initial quantity of symbols, or a quantity of coded bits per symbol in the initial quantity of symbols.

13. The apparatus of claim 1, wherein the one or more processors are, individually or collectively, configured to execute the instructions and cause the apparatus to output an indication of the first LDPC codeword length.

14. The apparatus of claim 13, wherein the indication of the first LDPC codeword length is outputted via a physical layer (PHY) header.

15. The apparatus of claim 13, wherein the indication of the first LDPC codeword length is outputted via a signal (SIG) field.

16. The apparatus of claim 13, wherein the indication of the first LDPC codeword length comprises one bit and corresponds to a first value of the first LDPC codeword length or the indication of the first LDPC codeword length comprises two bits and corresponds to a second value of the first LDPC codeword length.

17. The apparatus of claim 1, wherein the one or more processors are, individually or collectively, configured to execute the instructions and cause the apparatus to output second signaling indicating that the apparatus has turned off the use of the LDPC codeword length that is greater than or equal to the threshold LDPC codeword length.

18. The apparatus of claim 1, further comprising at least one transceiver configured to transmit the first signaling and the LDPC codeword, wherein the apparatus is configured as an access point (AP) or a wireless station (STA).

19. An apparatus for wireless communication, comprising:
at least one memory comprising instructions; and
one or more processors, individually or collectively, configured to execute the instructions and cause the apparatus to:
obtain first signaling indicating that a wireless node supports use of a first low-density parity check (LDPC) codeword length that is greater than or equal to a threshold LDPC codeword length when one or more conditions are satisfied; and
obtain, when one or more conditions are satisfied, an LDPC codeword of the first LDPC codeword length.

20. The apparatus of claim 19, wherein the one or more conditions are associated with at least one of: capability information of the apparatus, a bandwidth value, a resource unit (RU) size, a multiple RU (MRU) size, a modulation coding scheme (MCS) level, a number of spatial streams, a number of coded bits per orthogonal frequency division multiplexing (OFDM) symbol, a number of data bits per OFDM symbol, or one or more frequency bands for at least one of transmission or reception operations.

21. The apparatus of claim 20, wherein the one or more processors are, individually or collectively, configured to execute the instructions and cause the apparatus to output the capability information indicating that the apparatus supports use of the first LDPC codeword length that is greater than or equal to the threshold LDPC codeword length.

22. The apparatus of claim 19, wherein the one or more processors are, individually or collectively, configured to execute the instructions and cause the apparatus to obtain an indication of the first LDPC codeword length.

23. The apparatus of claim 22, wherein the indication of the first LDPC codeword length is obtained via a physical layer (PHY) header.

24. The apparatus of claim 22, wherein the indication of the first LDPC codeword length is obtained via a signal (SIG) field.

25. The apparatus of claim 22, wherein the indication of the first LDPC codeword length comprises one bit and corresponds to a first value of the first LDPC codeword length or the indication of the first LDPC codeword length comprises two bits and corresponds to a second value of the first LDPC codeword length.

26. The apparatus of claim 19, wherein the one or more processors are, individually or collectively, configured to execute the instructions and cause the apparatus to obtain second signaling indicating that the wireless node has turned off the use of the LDPC codeword length that is greater than or equal to the threshold LDPC codeword length.

27. The apparatus of claim 19, further comprising at least one transceiver configured to receive the first signaling and the LDPC codeword, wherein the apparatus is configured as an access point (AP) or a wireless station (STA).

28. A method for wireless communication performable at a first wireless node, comprising:
outputting first signaling indicating that the first wireless node supports use of a first low-density parity check (LDPC) codeword length that is greater than or equal to a threshold LDPC codeword length; and
outputting an LDPC codeword of the first LDPC codeword length when one or more conditions are satisfied.
